(19) United States
(12) Patent Application Publication
(10) Pub. No.: US 2009/0259684 A1
(43) Pub. Date: Oct. 15, 2009

(54) Digital content library service

(75) Inventors: Anthony David Knight, San Jose, CA (US); Mark Alan Hollar, Palo Alto, CA (US)

Correspondence Address: PATENT DEPARTMENT;MACROVISION CORPORATION, 2830 DE LA CRUZ BLVD., SANTA CLARA, CA, 95050, US

(73) Assignee: Macrovision Corporation

(21) Appl. No.: 12/082,123

(22) Filed: Apr. 9, 2008

(51) Int. Cl. G06F 17/00

(52) U.S. Cl. 707/104.1; 707/E17.009

(57) ABSTRACT

A digital content library service makes available copies of digital content in a customer's tangible media library to be transferable to a hard disk or other random access memory of a compatible media player for a fee. To ensure that only one copy is transferable per tangible medium, the medium is permanently marked as part of the data entry process for the service. Optionally, the service, by encapsulating the customer's usage entitlements, also enables its users, for an additional fee, to stream their libraries to certain internet enabled media players so that they may also enjoy access to their digital content in a variety of new environments.

### FIELD OF THE INVENTION

The present invention generally relates to the distribution of digital content and in particular, to a digital content library service.

### BACKGROUND OF THE INVENTION

Optical discs are widely used for distributing digital content such as music on compact discs (“CDs”) and movies on digital versatile discs (“DVDs”). As consumers expand their libraries of digital content on optical discs, however, the libraries become increasingly more cumbersome to use and keep track of.

Storage of digital content on random access memories such as hard disks for playback on personal computers (“PCs”) and flash memories for playback on portable media players (“PMPs”) overcomes many physical problems encountered with large libraries of optical discs. Additional benefits of random access memories include easier searching for and faster access to desired content for playback. Further, enhanced search capability, similar in usage to standard internet searching, may be possible with related metadata stored in addition to the digital content.

Although consumers are allowed to copy music purchased on CDs to their PCs and from their PCs to their PMPs, they are not allowed the same freedom to copy movies distributed on DVDs. Legal ripping solutions for DVD movies have been proposed, but there has been resistance to any notion of a secure managed copy, with some rights holders taking the position that content is forever married to the plastic it is shipped on. Some view attempts to copy content protected by the Content Scramble System (“CSS”) as either a violation of the Digital Millennium Copyright Act or a breach of applicable license agreements or the CSS Procedural Specifications.

### OBJECTS AND SUMMARY OF THE INVENTION

Accordingly, it is an object of one or more aspects of the present invention to provide a method and system for providing a digital content library service in which a customer may access his or her DVD library on a random access memory.

Another object of one or more aspects of the present invention is to provide a method and system for providing a digital content library service in which a one-to-one relationship may be enforced between a protected tangible medium and a corresponding electronic file provided as part of the digital content library service.

Another object of one or more aspects of the present invention is to provide a method and system for providing a digital content library service in which a customer may access his or her DVD library on a portable media player.

Another object of one or more aspects of the present invention is to provide a method and system for providing a digital content library service in which a customer is offered updated formats and/or sequels to digital content in his or her DVD library.

Another object of one or more aspects of the present invention is to provide a method and system for providing a digital content library service which does not require circumventing a digital rights management system intended to be used with individual DVDs in a customer's DVD library.

Still another object of one or more aspects of the present invention is to provide a method and system for providing a digital content library service which provides additional revenue and adequate safeguards against piracy of their digital content to content providers.

Yet another object of one or more aspects of the present invention is to provide a business method for providing a digital content library service achieving one or more of the above objects.

These and additional objects are accomplished by the various aspects of the present invention, wherein briefly stated, one aspect is a method for providing a digital content library service comprising: receiving a generated list of unique content identifiers for a library of tangible media in the possession of a customer; and offering to transfer copies of digital content corresponding to the list of unique content identifiers to the customer.

Another aspect is a method performed as part of a process for providing a digital content library service, comprising: determining whether a tangible medium possessed by a customer is permanently marked in a prescribed manner; and if the determination is no, then permanently marking the tangible medium in the prescribed manner, identifying the digital content, and transmitting the identification to a service provider so that the service provider may provide a licensed copy of the digital content to the customer.

Still another aspect is a system for providing a digital content library service, comprising: a reading device for reading an unique content identifier associated with digital content stored on a tangible medium in possession of a customer; a transmitting device coupled to the reading device for transmitting the unique content identifier; and a server for receiving the transmitted unique content identifier from the transmitting device and offering to transfer a copy of the digital content to the customer for a license fee.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a system for providing a digital content library service utilizing aspects of the present invention.

FIG. 2 illustrates a flow diagram of a method for generating a list of DVDs as part of a digital content library service utilizing aspects of the present invention.

FIG. 3 illustrates a flow diagram of a method for processing a list of DVDs as part of a digital content library service utilizing aspects of the present invention.

FIG. 4 illustrates a display screen showing a user's library as part of a digital content library service utilizing aspects of the present invention.

FIG. 5 illustrates a display screen showing movie information and viewing options as part of a digital content library service utilizing aspects of the present invention.

FIG. 6 illustrates a flow diagram of a method for processing a customer's retail purchase as part of a digital content library service utilizing aspects of the present invention.

### DETAILED DESCRIPTION OF THE PREFERRED EMBODIMENT

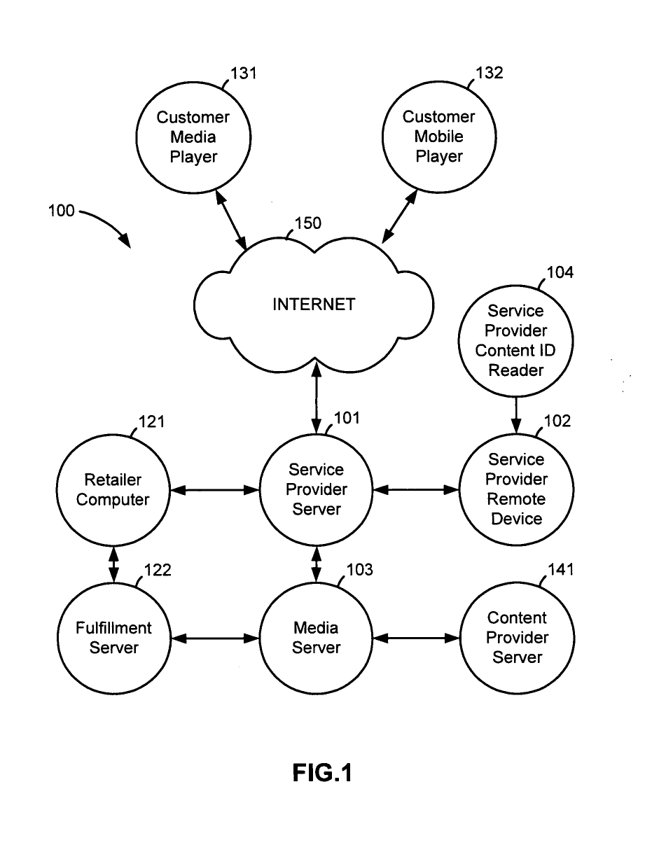

FIG. 1 illustrates a block diagram of a system 100 in which a service provider provides a digital content library service to its subscribers (also referred to as “customers”) using a server 101 which interacts with a number of other computers and devices as shown. The library service allows copies of digital content listed as being available for transfer in a customer's account to be made available to the customer for transferring (e.g., downloading by the customer) to a hard disk drive of a digital media player operated by the customer (such as customer media player 131) for a fee. The library service also allows digital content that has already been downloaded to the digital media player (i.e., the customer's library with the service) to be made available for playing on a portable media player operated by the customer (such as customer mobile player 132) for another fee, provided such usage right is permitted by the content owner through a business arrangement with the service provider (such as receiving a percentage of the fee charged by the service provider).

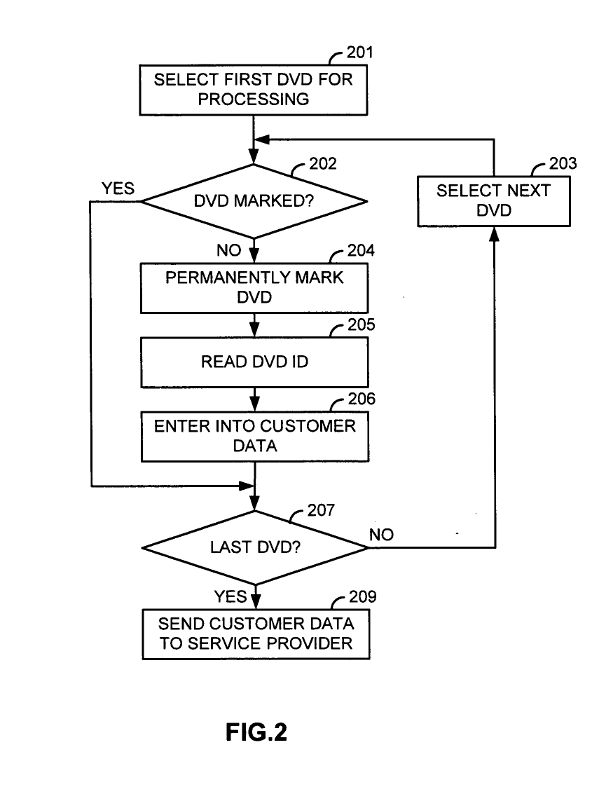

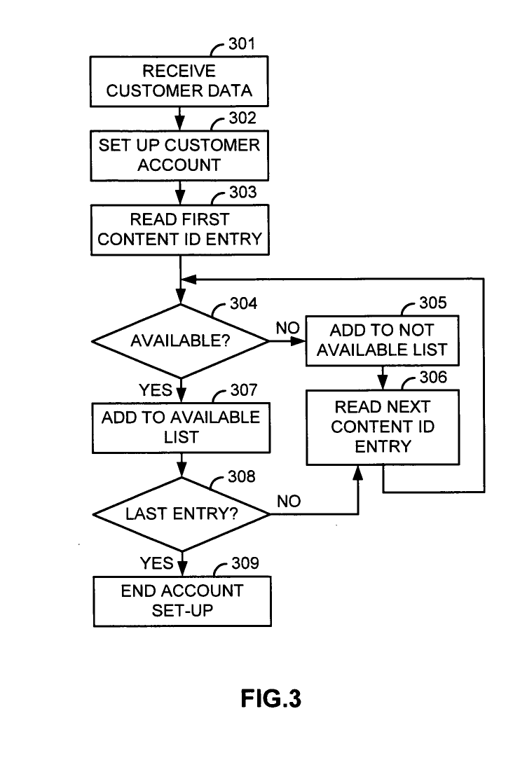

Each subscriber's account may be established and/or updated with the library service in a number of ways. For example, if the subscriber desires to have digital content from DVDs in the subscriber's possession included in the subscriber's account with the library service, then an agent (i.e., employee or contractor) for the service provider may come out to the subscriber's residence (or other convenient location) and transmit information of the subscriber and the subscriber's DVD library to the service provider server 101 using a remote communication device 102 according to the method described in reference to FIG. 2. Upon receiving the information, the service provider server 101 then creates and/or enters the received information into the subscriber's account according to the method described in reference to FIG. 3.

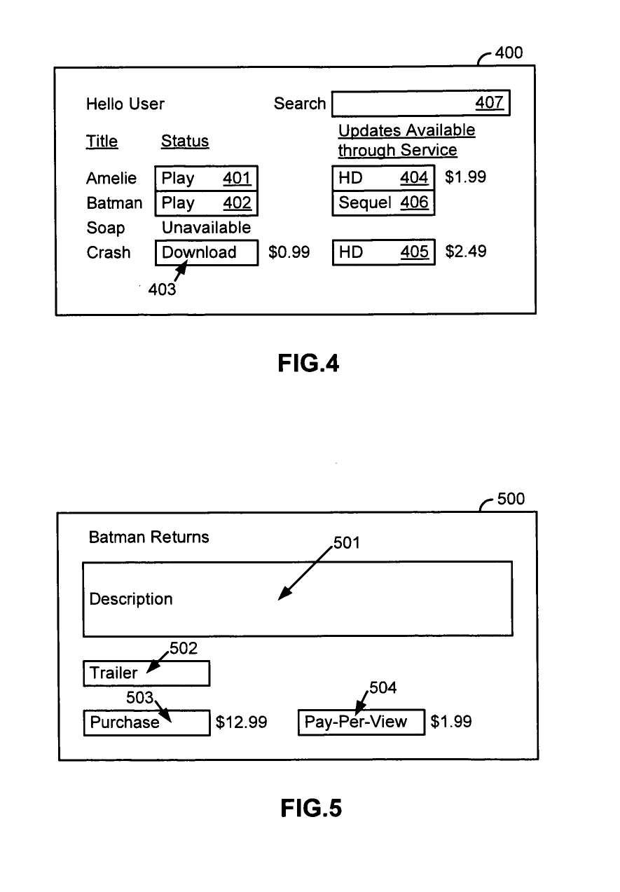

As another example, if the subscriber purchases (i.e., licenses) a copy of digital content directly from the service provider server 101 while logged-on his or her account, then a digital content identifier uniquely associated with the purchased content is entered directly into the subscriber's account. The digital content in this case may have been offered as an update (e.g., updated format or a sequel) to digital content already included in the customer's digital content library or it may have been offered as a result of a search query performed by the customer as described in reference to FIG. 4. Alternatively, the customer may have agreed at some time to automatically purchase the update when it becomes available. In that case, of course, the subscriber does not have to be logged-on in order to purchase update. The digital content may also have been offered as a result of the customer's viewing (or listening) habits or an interests survey completed by the customer at some time such as when first registering with the library service.

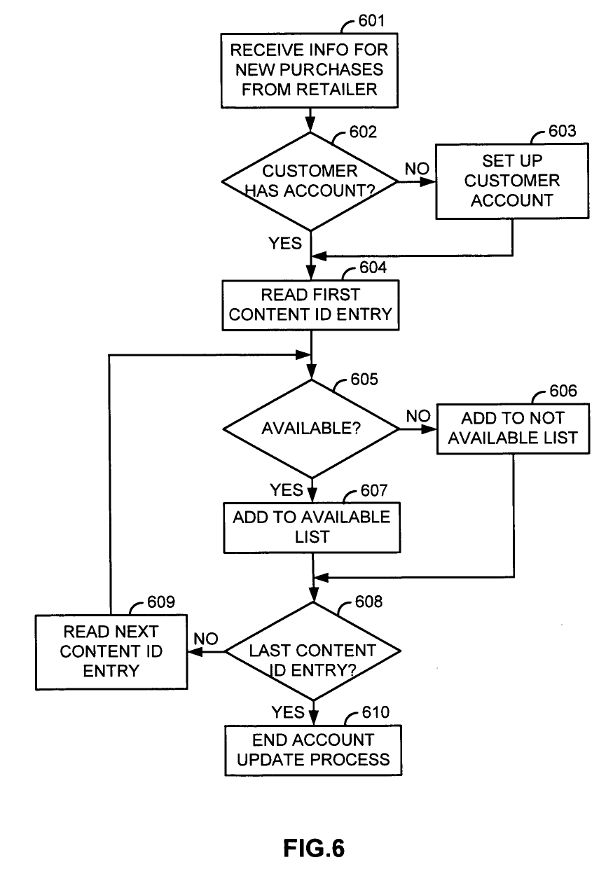

As yet another example, if the subscriber desires to have DVDs that the subscriber is purchasing at the time from a retailer included in the subscriber's account with the library service, then an employee of the retailer transmits information of the subscriber along with digital content identifications for each DVD purchased to the service provider server 101 using a retailer computer 121 according to the method described in reference to FIG. 6.

In order to make digital content available for transferring, the service provider first negotiates license agreements with content providers of the digital content and downloads or otherwise receives master copies of the licensed digital content from content provider servers operated by or for the content providers (such as content provider server 141). Transmission of the licensed digital content may occur over a direct line as shown in FIG. 1 or over the Internet 150 using conventional public-private key encryption or other secure transmission techniques.

A key component of the digital content library service is the customer's digital media player 131 which not only communicates with the service provider's server 101 over the Internet 150 to download, store, and play copies of digital content in the consumer's digital content library, but also ensures that the downloaded content is not illegally copied or otherwise transferred or made available to other devices. Thus, a prerequisite to participating in the digital content library service is for the consumer to first purchase from a retailer a digital media player that is compatible with the service. In order to interact with the digital media player, an input device such as keyboard and/or a pointing device is provided along with and coupled to the player as well as a means to access the Internet if not already available.

Before the retailer delivers the home player to a customer, however, an agent of the service provider first generates information for the customer's list of DVDs which is transmitted to the service provider server 101 as part of the digital content library service. The agent may be an employee or contractor of the service provider, or an employee or contractor of a retailer that has sold the digital media player to the customer. Although DVDs are used in the examples described herein to illustrate various aspects of the present invention, it is to be appreciated that the present invention is not to be limited as such and includes all tangible media as that term is understood to mean under copyright laws, examples of which include optical media, tape, flash memory, and the like.

FIG. 2 illustrates a flow diagram of a method performed by the agent of the service provider for generating information to be transmitted to the service provider server 101 for the customer's DVDs.

In 201, the service provider's agent selects a first DVD from the customer's collection for processing. In 202, the agent determines whether or not it is okay to provide a copy of the digital content on the DVD as part of the digital content library service by visually inspecting the DVD (and/or its cover) to determine whether it has been permanently marked in a prescribed manner, such as scoring the disc near the center ring, scoring the cover with a particular pattern at a particular location, or marking the disc or cover using permanent ink with a particular pattern at a particular location.

If the DVD has been permanently marked in the prescribed manner, then the determination in 202 is a YES. In this case, the agent rejects the current DVD for further processing and proceeds to 207 for further processing as described in detail below. On the other hand, if the DVD has not been permanently marked in the prescribed manner, then the determination in 202 is a NO. In this latter case, the method proceeds to 204 where the agent permanently marks the DVD in the prescribed manner, for example, using a scoring device, similar to a one-hole punch, to score the disk near the center ring, so that it may be processed only once. Consequently, only one transferable copy per DVD may be made available to the customer as part of the digital library service. This is significant, because the license fee for the transferable copy is significantly less than the normal price to download the digital content through the service because an existing retail version as been verified.

After permanently marking the DVD in 204, the method proceeds to 205 in which the agent reads an unique content identifier associated with the content stored on the DVD by, for example, scanning the DVD jewel case or DVD cover using a bar code scanner (one example of the content ID reader 104) to read the International Standard Book Number (“ISBN”) or reading the media using a media reader (another example of the content ID reader 104) to read an International Standard Audiovisual Number (“ISAN”), both of which uniquely identifies the digital content on the DVD. The unique content identifier (e.g., ISBN or ISAN) is then transmitted to a remote communication device such as the remote device 102 (which may be a Blackberry® or a notebook computer) through a Bluetooth or hardwired connection.

In 206, the unique content identifier for the current DVD is entered into a spreadsheet created on the remote communication device by the agent. In 207, the agent determines whether the current DVD is the last DVD to be processed. If it is, then in 209, the agent transmits customer information such as the customer's name and contact information along with the spreadsheet including the unique content identifier data for the customer's DVD library to the service provider server 101. The transmission of this information may be performed either over a phone line or through the Internet 150 using a conventional public/private key or other encryption technique. On the other hand, if it is determined by the agent in 207 that another DVD is to be processed, then the method jumps back to 203 and the agent selects another DVD from the customer's DVD library for processing through 202-209 as described above.

FIG. 3 illustrates a flow diagram of a method performed by the service provider server 101 for processing the spreadsheet of unique content identifier data generated and transmitted as described in reference to FIG. 2. In 301, the service provider server 101 receives the customer information and unique content identifier data spreadsheet from the remote communication device 102, and in 302, an operator or an application program running on the server 101 sets up a customer account using the provided customer information, if one hasn't already been set up for the customer.

In 303, a first unique content identifier entry in the spreadsheet is read and in 304, a determination is made by the application program running on the server 101 whether the first unique content identifier identifies a digital content that has already been licensed for distribution by the digital content library service. If the determination in 304 is NO, then the method proceeds to 305 where the unique content identifier is added to a not available list. Then in 306, the next unique content identifier entry is read from the spreadsheet and the method jumps back to 304 to determine whether the next unique content identifier is licensed.

If the determination in 304 is YES, however, then in 307, the unique content identifier is added to the customer's available list, which represents all items in the customer's DVD library which are licensed by the library service so that a copy of the digital content may be made available to the customer (either directly or through the retailer) for transfer. After adding the unique content identifier to the customer's licensed list, a determination is then made by the application program whether the unique content identifier is the last unique content identifier entry in the spreadsheet. If it is then in 309, the account set up process for the customer is ended. If the determination in 308 is NO, on the other hand, then the method jumps to 306 to read the next unique content identifier entry in the spreadsheet and then to loop through 304-308 until the last ISBN entry in the spreadsheet has been processed.

After the customer's account has been established and the customer's available and not available list of unique content identifiers generated, the customer may log-on the service provider's website and see titles of the digital content on his available and not available lists. Typically, this may be done within a short time after the service provider's agent has transmitted the unique content identifier spreadsheet to the service provider server 101 so that the agent may step the customer through the website while he or she is still with the customer so that the agent can show the customer that most, if not all, of the titles are available now to be provided in the library service. The agent also explains that while some of the titles may not be available now, when they are, the customer will be notified of that when the customer logs-on the service provider's website. In addition, the agent shows the customer that some of his digital content, such as movies that were originally in standard definition, are now also available for delivery in an updated format, such as high definition, for an additional fee.

Meanwhile back at the retailer's establishment, an employee of the retailer retrieves a digital media player from the retailer's inventory, such as the consumer media player 131, and connects the player to the retailer's fulfillment server 122 via a Universal Serial Bus (“USB”) connection or any other suitable manner. The fulfillment server 122 stores copies of digital content that it has previously downloaded from the service provider's media server 103. The employee then sends a fulfillment token onto the media player, and soon thereafter, copies of the digital content corresponding to unique content identifiers on the customer's available list are bound and delivered to the digital media player from the fulfillment server 122.

The next day, an employee or contractor of the retailer installs the digital media player 131 along with a wireless internet router (if the customer doesn't already have one) at the customer's home. The media player 131 is then plugged into the customer's television or flat panel display through its video and audio inputs, and is connected to the Internet 150 through the router which is connected to the customer's Internet Service Provider (“ISP”) through a modem. The customer may then immediately enjoy his or her digital content library using the media player 131. Over time, as digital content corresponding to unique content identifier entries on the customer's not available list become available, the customer will be notified after logging-on the service provider's website using the media player 131 and television so that the customer can securely download a copy of the content to the hard disk drive of the media player 131.

FIG. 4 illustrates, as an example, a user webpage 400 that is displayed on the customer's television after the user has logged-on the service through the media player 131. Each user in a family may have a different user identification and password to log-on the service in much the same way that different users may log-on a shared personal computer. Also like the shared personal computer, one of the users may be designated the system administrator and other users may be given limited rights such as the right to purchase content or the right to view certain content (e.g., using built-in parental guidance controls). For example, the system administrator may take advantage of metadata provided by the library service to set rules for every other user, for example, a child user may be prevented from seeing movies above PG-13, or from seeing movies in which a certain actor performs, or from seeing movies of a certain genre. To simplify the following description, the user in this example is assumed to have full rights with respect to the customer's digital content library.

The user webpage 400 shows the titles available for viewing from the customer's digital content library along with their status and information of any available updates through the service. In this example, the digital content includes the listed movies under the “Title” column. All listed movies in this example are standard formatted movies. The movies Amelie and Batman are available for viewing by clicking on their respective PLAY buttons 401 and 402 (e.g., they are on the customer's available list and copies of these movies have been transferred to the media player 131). The movie Soap is unavailable for viewing through the service at this time (e.g., it is still on the customer's not available list). The movie Crash, on the other hand, is available for transfer by clicking on the DOWNLOAD button 403 (e.g., it used to be on the customer's not available list, but now it is on the customer's available list). Adjacent the DOWNLOAD button 403 is a specified fee of $0.99 which the customer agrees to pay by clicking on the DOWNLOAD button 403. After transferring the movie Crash, the movie will be available for viewing and the DOWNLOAD button 403 will change to a PLAY button.

As indicated in the “Available Updates” column (i.e., updates available through the service provider), High Definition (“HD”) formatted versions of the movies Amelie and Crash are available for transfer by clicking on their respective HD buttons 404, 405. Adjacent to each of the buttons 404, 405 is a specified fee which the customer agrees to pay by clicking on the button. In this example, the fee for the HD version of Amelie is $1.99 and the fee for the HD version of Crash is $2.49. Note that the HD version of Crash is more expensive than Amelie, because a copy of the standard formatted version of Amelie has already been downloaded and paid for. The customer is encouraged to upgrade directly to the HD version of Crash, however, because the $2.49 price is less than the combined fee of $2.98 which is what it would cost to first download the standard formatted version of Crash (e.g., $0.99) and then upgrade that version to the HD formatted version (e.g., $1.99).

Also as indicated in the “Available Updates” column, a sequel to the movie Batman is available for purchase or rental. In this case, clicking on the SEQUEL button 406 causes another webpage 500 to be displayed on the customer's television. As shown in FIG. 5, the webpage 500 has a description section 501 that provides information about the sequel, Batman Returns, and three clickable buttons 502, 503, 504. Clicking the TRAILER button 502 plays a trailer of the movie Batman Returns. Clicking the PURCHASE button 503 downloads a copy of the movie to the hard disk of the media player 131, adds the movie to the customer's available content list, and adds the movie to the Title column of the user's webpage 400 along with an adjacent PLAY button in the Status column. Clicking on the PAY-PER-VIEW button 504 streams the movie to media player 131 for viewing on the customer's television. Adjacent the PURCHASE and PAY-PER-VIEW buttons 503, 504 are specified fees which the customer agrees to pay by clicking on their respective buttons.

Referring back to FIG. 4, the user's webpage 400 also has a Search area 407 in which the user can enter conventional keyword search queries to search for movies. To facilitate the search, standard metadata, such as the Title of the movie and the Names of its starring actors, are provided along with each movie downloaded to the media player 131 from the service provider server 101. In addition to being able to search the consumer's digital content library, the search may also include other movies available from the service provider. When a movie listed in the search results is not in the consumer's library, then clicking on the title of that movie causes a webpage, such as the webpage 500, to be displayed on the television screen so that the user is provided a description of the movie and clickable buttons to see a free trailer, purchase the movie for a specified fee, or rent the movie for another specified fee (i.e., view the movie on a pay-per-view basis), as described in reference to webpage 500 of FIG. 5. As previously explained, parental controls using metadata provided by library service may be configured in the media player 131 by the system administrator to restrict what individual users may search for, purchase and/or view.

As mentioned in reference to 305 of FIG. 3, when the digital content on a DVD in the customer's DVD library is not available for downloading from the service provider, because the service provider does not yet have license rights from the content provider to do so, its unique content identifier is placed in a not available list and the user's webpage 400 indicates such unavailability by the designation UNAVAILABLE in the Status column.

Meanwhile, the service provider makes continuing efforts to obtain licensing rights for the not available content to perform its digital content library service. If the content provider is unfamiliar with the library service, an employee of the service provider explains that a primary part of its service is to provide copies of digital content already in the lawful possession of its customers in their respective DVD (or other tangible media) libraries to a hard disk of a digital media player associated with the service so that the customers may easily store, access, and play the digital content on a television (or other display screen) connected to the digital media player while the digital media player ensures that the content is not further copied or otherwise transferred or made available to another device. A fee is charged for each copy transferred to a customer and the transferred copies are referred to as the customer's digital content library. A second part of the service allows customers to stream content included in their digital content libraries to portable media players so that they may enjoy their library “on the go” as well as at home. A monthly subscription is charged for this part of the service. A third part of the service is to offer customers downloadable updates (e.g., updated formats) and sequels to digital content in their library at standard distribution prices. A fourth part of the service is a conventional content distribution function wherein content not currently in the customer's digital content library are made available for downloading and inclusion in the customer's library by purchase or for one-time viewing on a pay-per-view basis. The fees for this part of the service would also be at standard pricing. In exchange for licensing rights to include their digital content in the service, content providers receive shares of the fees charged for the various parts of the service.

If the content provider is not willing to license its digital content to the library service provider at the current time, then the employee leaves the unique content identifier entry in the customer's non-licensed list. On the other hand, if the content provider agrees to license the current unique content identifier's digital content to the library service provider, then a license agreement is executed with the content provider for the content (as well as any other digital content that the content provider is willing to include in the license agreement) and a master copy of the unique content identifier's digital content is downloaded or otherwise obtained from the content provider's server 141 and stored in the service provider's media server 103 (along with standard metadata associated with the content). The unique content identifier entry for the now licensed digital content is then removed from the customer's not available list and added to the customer's available list of digital content. The new entry to the customer's available list is then indicated on the user's webpage with a DOWNLOAD button such button 403 of FIG. 4.

FIG. 6 illustrates, as an example, a flow diagram of a method performed by the service provider server 101 for processing a customer's retail purchase as part of the digital content library service. In 601, the server 101 receives information for new DVD purchases from a retailer computer such as retailer computer 121. In 602, a determination is made whether the customer identified in the received information already has a customer account. If the determination in 602 is YES, then the method proceeds directly to 604. On the other hand, if the determination in 602 is NO, then the method proceeds to 603 where a customer account is set up for customer before proceeding to 604.

In 604, a unique content identifier entry scanned in by the retailer using a bar code scanner for the ISBN or otherwise read from the purchased copy of the digital content itself for the ISAN is read for the first DVD purchased. In 605, a determination is made whether the digital content corresponding to the unique content identifier has been licensed by the library service provider from its content provider to perform the various parts of the digital content library service. If the content has not been licensed yet, then in 606 the unique content identifier is added to the customer's not available list and the method proceeds to 608. On the other hand, if the content corresponding to the unique content identifier has been licensed from its content provider, then in 607 the unique content identifier is added to the customer's available list before the method proceeds to 608.

In 608, a determination is made whether the current unique content identifier entry is the last unique content identifier entry in the received DVD purchase information. If the determination is NO, then in 609, the next unique content identifier entry is read and method jumps back to 605 to loop through 605-609 for the next unique content identifier entry. If the determination in 608 is YES, however, then the method terminates in 610 because it has completed processing information for all newly purchased DVDs. The new entries to the available and not available lists are then handled in the same fashion as the prior entered items in those lists as described in reference to FIGS. 3-5 above.

Although the various aspects of the present invention have been described with respect to a preferred embodiment, it will be understood that the invention is entitled to full protection within the full scope of the appended claims.

What is claimed is:

1. A method for providing a digital content library service comprising:
receiving a generated list of unique content identifiers for a library of tangible media in the possession of a customer; and
offering to transfer copies of digital content corresponding to the list of unique content identifiers to the customer.

2. The method according to claim 1, wherein the offered copies of digital content are provided so as to be bound to a media player used for receiving transferred copies of the digital content.

3. The method according to claim 1, wherein each tangible medium of the library has been permanently marked in a prescribed manner as part of the process of generating the list of unique content identifiers.

4. The method according to claim 1, further comprising:
receiving customer information including an identification of the customer; and
setting up a customer account for the customer including status information for the copies of digital content being offered to the customer for transfer.

5. The method according to claim 4, wherein the offering of the transferable copies and the status information are provided to the customer on a webpage accessed by the customer over the Internet.

6. The method according to claim 1, further comprising:
receiving a request initiated by the customer on a mobile player to play digital content on the mobile player; and
streaming the requested digital content to the mobile player if the customer has agreed to pay a fee.

7. The method according to claim 1, wherein the unique content identifiers are international standard book numbers scanned from covers of the tangible media.

8. The method according to claim 1, wherein the unique content identifiers are international standard audiovisual numbers read from digital content on the tangible media.

9. A method performed as part of a process for providing a digital content library service, comprising:
determining whether a tangible medium possessed by a customer is permanently marked in a prescribed manner; and
if the determination is no, then permanently marking the tangible medium in the prescribed manner, identifying the digital content, and transmitting the identification to a service provider so that the service provider may provide a copy of the digital content to the customer.

10. The method according to claim 9, wherein the tangible medium is an optical disc and the digital content is an audiovisual work.

11. The method according claim 9, wherein the tangible medium is a tape and the digital content includes at least audio data.

12. The method according to claim 9, wherein the prescribed manner of marking the tangible medium is to score the tangible medium so as not to impair playing the digital content on the tangible medium.

13. The method according to claim 9, wherein the prescribed manner of marking the tangible medium is to mark the tangible with permanent ink.

14. The method according to claim 9, wherein the identification of the digital content comprises:
scanning a protective cover of the tangible medium to read an international standard book number assigned to the digital content.

15. The method according to claim 9, wherein the identification of the digital content comprises:
reading an international standard audiovisual number assigned to the digital content from the digital content stored on the tangible medium.

16. A system for providing a digital content library service, comprising:
a reading device for reading a unique content identifier associated with digital content stored on a tangible medium in possession of a customer;
a transmitting device coupled to the reading device for transmitting the unique content identifier; and
a server for receiving the transmitted unique content identifier from the transmitting device and offering a transferable copy of the digital content to the customer for a license fee.

17. The system according to claim 16, further comprising:
a marking device for permanently marking the tangible medium in a prescribed manner so as not to impair playing digital content on the tangible medium, wherein the marking device is used to ensure that the transmitting device only transmits the unique content identifier one time for the tangible medium.

18. The system according to claim 16, further comprising:
a media player for allowing the customer to access the webpage of the server, download the copy of the digital content using the webpage so that the copy is bound to the media player, and play the copy.

19. The system according to claim 16, further comprising:
a retailer reader for reading an unique content identifier associated with digital content on a tangible medium purchased by the customer; and
a retailer computer coupled to the retailer reader for transmitting the unique content identifier to the server so that the server may offer a transferable copy of the digital content on the purchased tangible medium to the customer for a license fee on a webpage accessible by the customer.

20. The system according to claim 16, further comprising:
a mobile player for allowing the customer to request a stream of the digital content from the server and play the streamed digital content.
